(19) United States
(12) Patent Application Publication
(10) Pub. No.: US 2009/0112636 A1
(43) Pub. Date: Apr. 30, 2009

(54) Investment-Linked Insurance Apparatus and Method

(75) Inventors: Yung-Sung Chien, Taipei City (TW); Frank Kuen-Bao Ling, Taipei City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: SHACOM. COM INC., Taipei City (TW)

(21) Appl. No.: 12/262,926

(22) Filed: Oct. 31, 2008

(30) Foreign Application Priority Data
Oct. 31, 2007 (TW) 096141036
Nov. 14, 2007 (TW) 096142989
Oct. 1, 2008 (TW) 097137822
Oct. 9, 2008 (TW) 097139043

(51) Int. Cl. G06Q 40/00

(52) U.S. Cl. 705/4; 705/37; 705/40

(57) ABSTRACT

An investment-linked insurance apparatus and method are provided. The investment-linked insurance apparatus comprises an insurance process module, a cash flow module, a credit evaluation module, a bid process module, and a database. The insurance process module receives an insurance request of an applicant. The cash flow module receives a payment of a premium of the applicant. The credit evaluation module determines whether a credit line of the applicant is greater than the predetermined amount. The insurance process module issues an investment-linked policy of the applicant in response to the payment. The bid process module receives a placed bid of a current bid term of the applicant and calculates a predetermined bid of the current bid term. By the investment-linked insurance apparatus and method, an applicant can buy the investment-linked policy in a user-friendly environment.

This application claims the benefit from the priority of Taiwan Patent Application No. 096141036 filed on Oct. 31, 2007, Taiwan Patent Application No. 096142989 filed on Nov. 14, 2007, Taiwan Patent Application No. 097137822 filed on Oct. 1, 2008, and Taiwan Patent Application No. 097139043 filed on Oct. 9, 2008, the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to an investment-linked insurance apparatus and method; more particularly, related to an investment-linked insurance apparatus and method that are user-friendly and provide more flexibility.

2. Descriptions of the Related Art

Insurance has been evolved for several hundred of years, which is a popular system in most economy freedom countries. By paying a predetermined amount of money periodically, people can issue insurance claim payment when they are injured, their property are damaged, or the like.

Nowadays, insurance companies provides many types of insurances, such as health insurance, casualty insurance, property insurance, life insurance, etc. The scale and amount of health insurance and casualty insurance reflect the economy status of a country. In 2006, there are 84% of residences have health insurances, which can be government sponsored, employer sponsored, or individual purchased. Similarly, the scale and amount of property insurances reflect the economic activities of a country. In the year 2002, the total premium of life insurances in the United States is one million million dollars, wherein the property insurances contribute 52% of them. In the year 2006, the total premium of property insurances in Taiwan is only about eleven thousand million dollars, which only contribute 6.8% of the life insurance. The insurance companies propose several different types of insurance to expand the business. For example, the U.S. Pat. No. 6,236,973 B1 discloses apparatus and method that combine the ideas of insurance and loan. The U.S. Pat. No. 6,772,128 B2 discloses an insurance product and method relates to nuclear decommissioning. Unfortunately, most of the insurance types and the content of insurance policies still do not meet the need of applicants.

Another difficulty faced by most applicants is that they can not reach information related to insurances easily. The U.S. Pat. No. 4,491,725 discloses a medical insurance verification and processing system, which can store information of applicants so that premiums can be easily calculated. The U.S. Pat. No. 5,070,452 further improves the aforementioned system by disclosing approaches to input, store, and update information of applicants.

According to the aforementioned descriptions, the types of current insurances are still limited and the contents of insurance policies are still strict. Once an applicant buys an insurance policy, he or she has to pay the premium and cannot use the money anymore. Besides, applicants cannot access the information easily via their own computers at home. Consequently, there is a need for a user-friendly system that combines insurance with other finance management abilities and that can be accessed by users via network.

### SUMMARY OF THE INVENTION

An objective of this invention is to provide an investment-linked insurance apparatus. The investment-linked insurance apparatus comprises an insurance process module, a cash flow module, a credit evaluation module, a bid process module, and a database. The insurance process module is configured to receive an insurance request of an applicant, create an investment-linked policy of the applicant, and issue an investment-linked policy in response to a payment of a premium of the applicant. The insurance request includes an insurance subject-matter, while the investment-linked policy includes the insurance subject-matter, an amount of insurance, the premium, a policy period, and a bid record. The bid record comprises a total bid terms, a basis bid, a bid limit, and a predetermined amount. The cash flow module is configured to receive the payment of the premium of the applicant. The credit evaluation module is configured to determine a credit line of the applicant being greater than the predetermined amount. The bid process module is configured to receive a placed bid of a current bid term of the applicant and calculate a predetermined bid of the current bid term. The database is configured to store the investment-linked policy. The bid process module is further configured to calculate a current bid amount of the current bid term for the applicant according to the bid limit and one of the placed bid and the predetermined bid.

Another objective of this invention is to provide an investment-linked insurance method, which is adapted to an investment-linked insurance apparatus. The investment-linked insurance method enabling the investment-linked insurance apparatus to do the following step: (a) receiving an insurance request of an applicant, the insurance request including an insurance subject-matter; (b) creating an investment-linked policy of the applicant, the investment-linked policy including the insurance subject-matter, an amount of insurance, a premium, a policy period, and a bid record, the bid record comprising a total bid terms, a bid limit, and the predetermined amount; (c) storing the investment-linked policy in a database; (d) determining a credit line of the applicant being greater than the predetermined amount; (e) receiving a payment of a premium of the applicant; (f) issuing an investment-linked policy of the applicant in response to the receiving of the insurance payment; (g) calculating a predetermined bid of a current bid term; (h) receiving a placed bid of the current bid term of the applicant; and (i) calculating a current bid amount of the current bid term for the applicant according to the bid limit and one of the placed bid and the predetermined bid.

According to the aforementioned descriptions, the investment-linked insurance apparatus and method or the present invention provides a user-friendly environment for an applicant who intends to buy insurances. Furthermore, the investment-linked policy provided by the investment-linked insurance apparatus and method combines the idea of insurance and investment, which offers the applicant more flexibility in handling the money.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates an embodiment of an investment-linked insurance apparatus of the present invention;

FIG. 2A illustrates a first part of the flowchart of an investment-linked insurance method of the present invention;

FIG. 2B illustrates a second part of the flowchart of the investment-linked insurance method of the present invention;

FIG. 2C illustrates a third part of the flowchart of the investment-linked insurance method of the present invention; and

FIG. 2D illustrates a fourth part of the flowchart of the investment-linked insurance method of the present invention.

### DESCRIPTION OF THE PREFERRED EMBODIMENT

In the descriptions that follow, the present invention will be described in reference to the descriptions and examples about an investment-linked insurance apparatus and method. However, the descriptions and examples of the invention are not limited to any particular environment, application, or implementation. Therefore, the descriptions and examples that follow are for purposes of illustration but not limitation. It should be appreciated that, in the following embodiments and the attached drawings, elements unrelated to this invention are omitted from depiction; dimensional relationships among individual elements in the attached drawings are illustrated only for ease of understanding, but not to limit the actual scale.

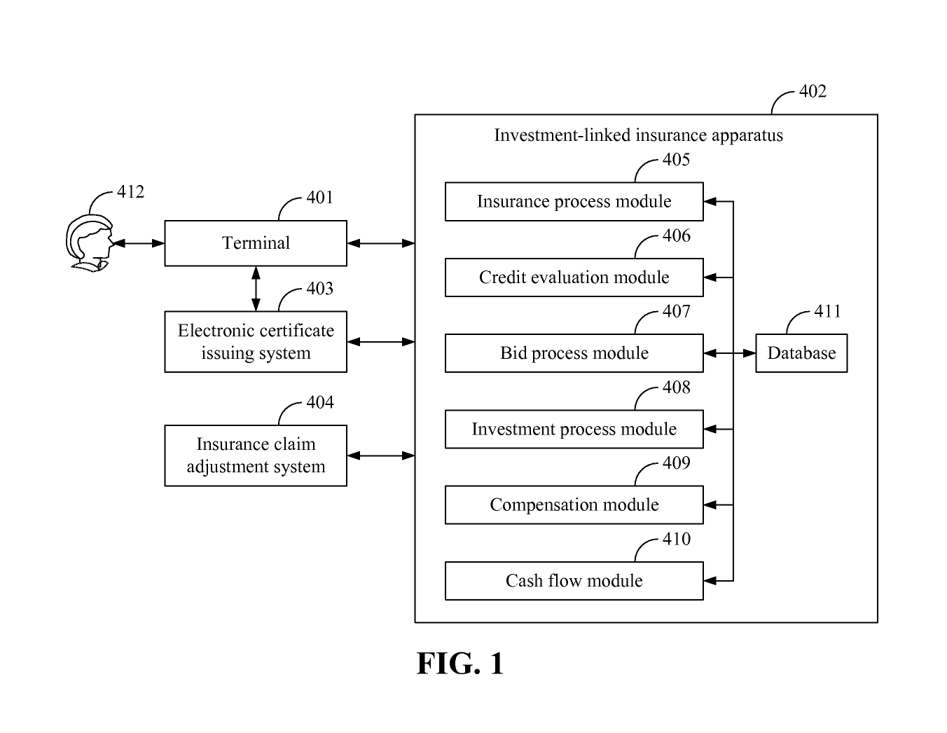

A first embodiment of the present invention is an investment-linked insurance apparatus 402, which is illustrated in FIG. 1. The investment-linked insurance apparatus 402 comprises an insurance process module 405, a credit evaluation module 406, a bid process module 407, an investment process module 408, a compensation module 409, a cash flow module 410, and a database 411. The investment-linked insurance apparatus 402 can be a server, a computer, or the like. The investment-linked insurance apparatus 402 is connected to a terminal 401 of an applicant 412, an insurance claim adjustment system 404 of an insurance company, and an electronic certificate issuing system 403. These connections may be in a wired or a wireless fashion.

The terminal 401 may be one of a desktop, a laptop, a cell phone, a personal digital assistant, and so on. The terminal 401 is connected to the electronic certificate issuing system 403 so that the applicant 412 can derive an electronic certificate of his or her own from the electronic certificate issuing system 403 via the terminal 401. Similarly, the connection between the terminal 401 and the electronic certificate issuing system 403 may be wired or wireless in this embodiment. In other embodiments, if the applicant 412 already has the electronic certificate, the terminal 401 is not required to be connected to the electronic certificate issuing system 403.

When the applicant 412 intends to buy an insurance product from the insurance company, the applicant 412 logins the investment-linked insurance apparatus 402 by the electronic certificate. The insurance process module 405 receives the electronic certificate of the applicant 412 from the terminal 401. Afterwards, the insurance process module 405 submits the electronic certificate to the electronic certificate issuing system 403. In response to the submission of the electronic certificate, the insurance process module 405 receives a piece of basic information (occupation, income, etc.) of the applicant 412 from the electronic certificate issuing system 403 according to the electronic certificate. The insurance process module 405 examines the basic information of the applicant 412 and then stores the piece of basic information of the applicant 412 in the database 411. People skilled in the art should be familiar with the operations of the electronic certificate, so they are not detailed here.

The applicant 412 submits an insurance request to the insurance process module 405, wherein the insurance request includes an insurance subject-matter. Depending on the requirement of the applicant 412, the insurance request may pertain to one of a property insurance, a health insurance, a casualty insurance, and the combination thereof. Further more, the property insurance may be pertain to a fire insurance, a marine insurance, a liability insurance, or the like. The insurance subject-matter may be a real estate, personal estate, or an indemnity of liability insurance. For example, the insurance request of the applicant 412 may ask for a three-year fire insurance and the insurance subject-matter is an apartment of the applicant 412.

In response to the submission, the insurance process module 405 receives the insurance request of the applicant 412 from the terminal 401. The insurance process module 405 examines a physical hazard (such as age of the applicant 412, gender of the applicant 412, status of insurance subject-matter, etc.) and a non-physical hazard of the applicant 412 (such as job of the applicant 412, finance status of the applicant 412, etc.). In response to the examination of the insurance process module 405, the insurance process module 405 creates an investment-linked policy of the applicant 412, wherein the investment-linked policy includes the insurance subject-matter, an amount of insurance, a premium and a policy period. The investment-linked policy is stored in the database 411.

The credit evaluation module 406 decides a credit line of the applicant 412 according to one of a credit information of the applicant 412, a collateral of the applicant 412, the investment-linked policy of the applicant 412, and the combination thereof. The credit evaluation module 406 stores the credit line of the applicant 412 in the database. The credit evaluation module 406 further determines whether the credit line of the applicant 412 is greater than the predetermined amount included in the bid record. If the credit line of the applicant 412 is greater than a predetermined amount, the insurance process module 405 updates the investment-linked policy so that the investment-linked policy further includes a bid record. The bid record comprises a total bid terms, a basis bid, a bid limit, and the predetermined amount. The total bid terms is decided according to the policy period.

Continued with the aforementioned example (i.e. the applicant 412 asking for a three-year fire insurance), the insurance process module 405 decides the amount of insurance to be five million dollars, the premium to be $2,500 per year, the policy period to be three years, the basis bid is $400, and the bid limit is $10,000. The amount of insurance is decided according to the value of the insurance subject-matter (i.e. the apartment) of the applicant 412, while the policy period is decided according to the indication of the insurance request of the applicant 412. The insurance process module 405 further decides the total bid terms to be thirty six, which means each of the bid terms corresponding to one month. It is noted that the insurance process module 405 may decide each of the bid terms to be corresponded to other time interval (such as one bid term corresponding to two months). The total bid terms, the bid limit, and the predetermined bid will be detailed later.

The insurance process module 405 transmits the investment-linked policy to the applicant 412. If the applicant 412 agrees with the content of the investment-linked policy, the applicant 412 pays a payment of the premium included on the investment-linked policy through the terminal 401. The cash flow module 410 receives a payment of the premium of the applicant 412 from the terminal 401. The insurance process module 405 issues the investment-linked policy to the applicant 412 in response to the receiving of the payment. Afterwards, the investment-linked policy is effective.

After the investment-linked policy becomes effective, the applicant 412 may decide whether to bid every bid term. For each bid term, if the applicant 412 decides not to bid, the bid process module 407 calculates a current bid amount of the applicant 412 by subtracting the basis bid from the bid limit; that is $9,600 (i.e. $10,000-$400). The current bid amount of $9,600 is to be paid by the applicant 412. It means that the current bid amount is a contribution amount, when the applicant 412 decides not to bid.

If the applicant 412 decides to bid, the bid process module 407 calculates a predetermined bid of the current bid term. The predetermined bid may be calculated according to one-year average deposit interest rate, other interest rates, or the like. For example, the bid process module 407 calculates the predetermined bid of the first bid term to be $600. It is noted that the applicant 412 does not know the predetermined bid. Then, the bid process module 407 receives a placed bid of the current bid term of the applicant 412. If the placed bid is smaller than the predetermined bid, say $600, then the bid process module 407 calculates the current bid amount of the applicant 412 by subtracting the placed bid from the bid limit; that is $9,400 (i.e. $10,000-$600). The current bid amount of $9,400 is to be paid by the applicant 412. It means that the current bid amount is a contribution amount, when the placed bid is smaller than the predetermined bid.

For each of the other bid terms, the bid process module 407 also performs the below tasks. If the applicant 412 also decides not to bid for that current bid term, then the applicant 412 also has to pay a current bid amount of the bid limit minus the basis bid. If the applicant 412 decides to bid, the bid process module 407 also calculates a predetermined bid of that current bid term. If the placed bid of the applicant 412 of that current bid term is also smaller than the corresponding predetermined bid, then the applicant 412 also has to pay a current bid amount of the bid limit minus the placed bid. For example, if the placed bid of the applicant 412 in the next bid term is $500 and the predetermined bid is $700, the applicant 412 has to pay the current bid amount of $9,500 (i.e. $10,000-$500). It is noted that the predetermined bid and the placed bid may be different from bid term to bid term.

Assume that the applicant 412 never bids when the insurance process module 405 determines the policy period ending. In response to the end of the policy period, the insurance process module 405 calculates a repayment by multiplying the bid limit and a value of the total bid terms minus one when the policy period ends. The repayment is equal to $350,000 ($10,000×35) and the repayment is to be received by the applicant in response to the ending of the policy period. Similarly, if the placed bid of the applicant 412 is always smaller than the corresponding predetermined bid, the insurance process module 405 also calculates the repayment by multiplying the bid limit and a value of the total bid terms minus one when the policy period ends. The repayment is also to be received by the applicant 412 in response to the ending of the policy period.

Assume that the applicant 412 desires to win the bid after 23 bid terms. When the current bid term is the twenty fourth bid term, the applicant 412 places a placed bid of $1,000. The bid process module 407 receives the placed bid of the current bid term of the applicant 412. Meantime, assume that the predetermined bid of the current bid term (the twenty fourth bid term) is $625. Since the placed bid is greater than the predetermined bid, the bid process module 407 calculates the current bid amount by the following equation:

A=(U−I)×(N−n)+U×(n−1);

wherein A denotes the current bid amount, U denotes the bid limit, N denotes the total bid terms, n denotes the current bid term, and I denotes the placed bid. As a result, the current bid amount is $338,000 (i.e. ($10,000−$1,000)×(36−24)+$10,000×(24−1)). The current bid amount of $338,000 is to be received by the applicant. It means that the current bid amount is a bid-winning amount, when the placed bid is not smaller than the predetermined bid.

In other embodiment, the bid process module 407 may use the following equation to calculate the current bid amount when the placed bid is not smaller than the predetermined bid:

$$A = U \times ( N - n ) + U \times ( n - 1 ) + {\sum }_{i = j}^{n - j} {I}_{i} ;$$

wherein Iᵢ denotes the placed bids of each bid winner of all the passed terms.

In response to the applicant 412 receiving the current bid amount, the investment process module 408 provides a plurality of investment vehicle for the applicant 412. The applicant 412 may select at least one of the investment vehicles to invest. The investment process module 408 then receives the at least one selected investment vehicle of the applicant 412 and store the at least one selected investment vehicle into the database 411. The applicant 412 can use the current bid amount (i.e. $338,000) to invest the at least one selected investment vehicle. A net asset value of the at least one selected investment vehicle of the applicant 412 is stored in the database 411 as well.

After the applicant 412 receives the current bid amount, the applicant 412 has to pay an amount of the bid limit for the rest of bid terms (i.e. each of the bid terms in the future). It means that the cash flow module 410 will receives a payment of the bid limit every future term from the applicant 412. Continued with the above example, the cash flow module 410 will receives a payment of $10,000 for each of the rest twelve bid terms.

When the insurance process module 405 determines that the policy period ends, the insurance process module 405 decides the repayment of the applicant to be equal to the net asset value, wherein the repayment is to be received by the applicant 412 in response to the ending of the policy period. If the net asset value is $365,040, the applicant 412 will receive $365,040. The benefit is better than just saving the money in the checking account, which is equal to $360,000.

It is possible that the applicant 412 requests for issuing insurance claim payment during the policy period. For that situation, the applicant 412 has to transmit a request for issuing insurance claim payment from the terminal 401. In response to the transmission, the compensation module 409 receives the request for issuing insurance claim payment of the applicant 412 and transmits the request for issuing insurance claim payment to the insurance claim adjustment system 404. The insurance claim adjustment system 404 checks the invalidity of the request for issuing insurance claim payment. If the insurance claim adjustment system 404 confirms the request for issuing insurance claim payment after the check, the insurance claim adjustment system 404 calculates a claim amount, wherein the claim amount is related to the amount of insurance. For example, the claim amount may be equal to the amount of insurance, such as the aforementioned five million dollars. Meantime, the insurance process module 405 calculates a repayment according to the aforementioned approach. A summation of the claim amount and the repayment is to be received by the applicant 412.

According to the aforementioned arrangement, the investment-linked insurance apparatus provides a user-friendly environment for an applicant who intends to buy insurances. Applicant can access all the information at the terminal as long as the terminal has an electronic certificate of the applicant and is connected to the investment-linked insurance apparatus. Furthermore, the investment-linked policy provided by the investment-linked insurance apparatus combines the idea of insurance and investment, which offers the applicant more flexibility in handling the money.

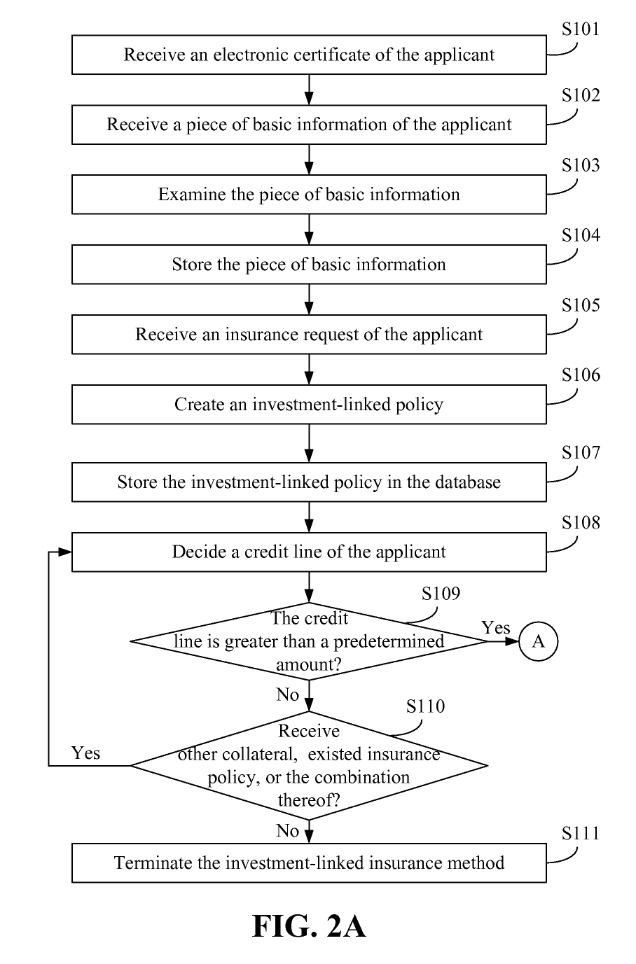

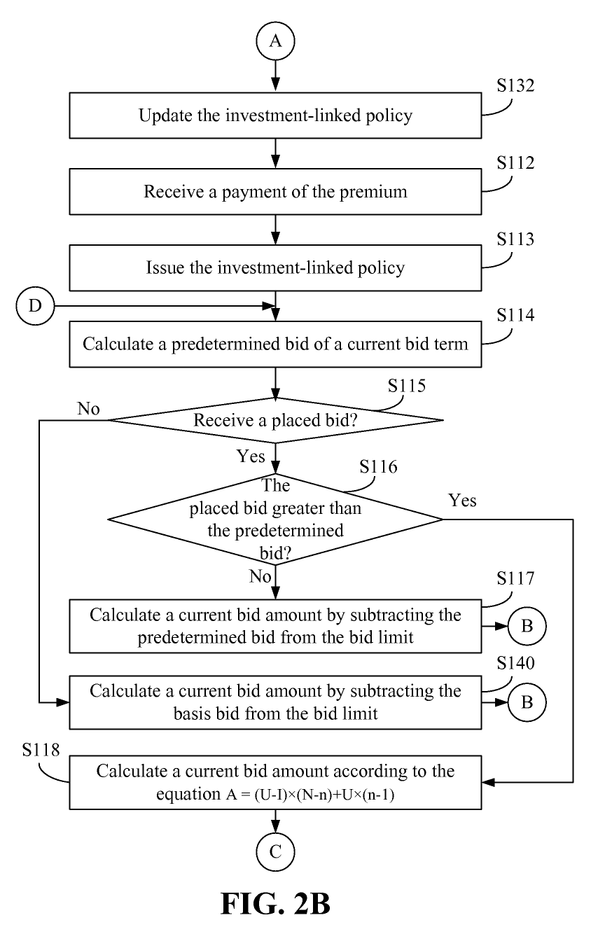

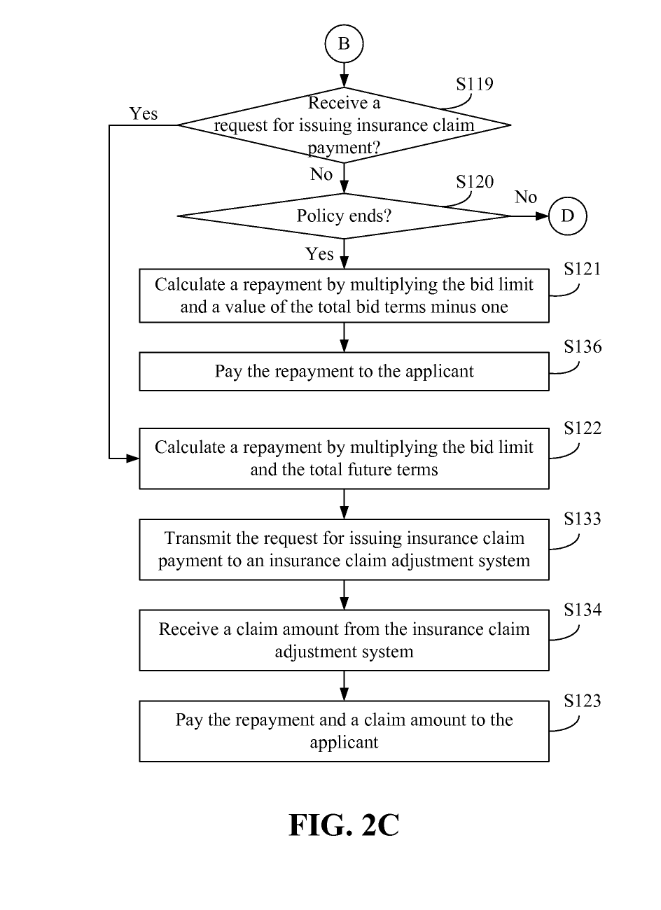

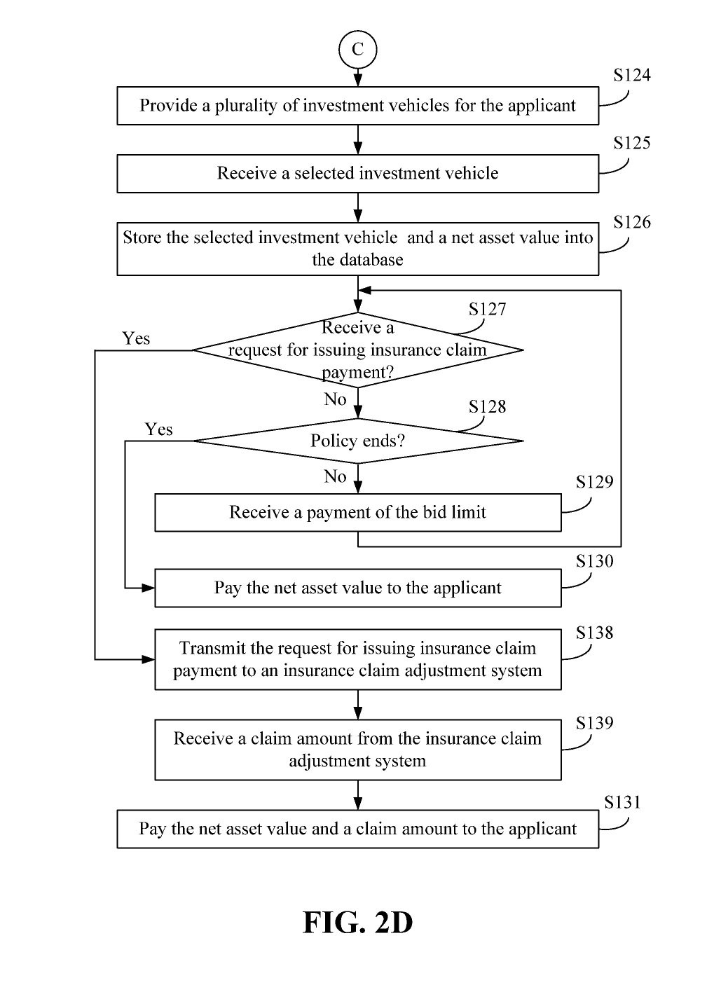

A second embodiment of the present invention is an investment-linked insurance method, whose flowchart is illustrated in FIGS. 2A, 2B, 2C, and 2D. The investment-linked insurance method is adapted to the investment-linked insurance apparatus 402 of the first embodiment.

When an applicant intends to buy an insurance product, the investment-linked insurance method first executes step S101 to enable the investment-linked insurance apparatus 402 to receive an electronic certificate of the applicant. Next, step S102 is executed to enable the investment-linked insurance apparatus 402 to receive a piece of basic information of the applicant according to the electronic certificate from the electronic certificate issuing system 403. The investment-linked insurance method then executes steps S103 and S104 to enable the investment-linked insurance apparatus 402 to examine the piece of basic information and store the piece of basic information in a database 411, respectively.

Then, step S105 is executed to enable the investment-linked insurance apparatus 402 to receive an insurance request of the applicant, wherein the insurance request includes an insurance subject-matter. The insurance request may be pertain to one of a property insurance, a health insurance, a casualty insurance, and the combination thereof. Afterwards, steps S106 and S107 are respectively executed to enable the investment-linked insurance apparatus 402 to create an investment-linked policy and store the investment-linked policy in the database 411. The investment-linked policy includes the insurance subject-matter, an amount of insurance, a premium, a policy period.

Next, step S108 is executed to enable the investment-linked insurance apparatus 402 to decide a credit line of the applicant according to one of a credit information, a collateral, the investment-linked policy created in step S106, and the combination thereof. Next, step S109 to enable the investment-linked insurance apparatus 402 to determine whether the credit line is greater than a predetermined amount. If it is not, step S110 is executed to enable the investment-linked insurance apparatus 402 to determine whether to receive other collateral, existed insurance policy, or the combination thereof. If it is not in step S110, step S111 is executed to enable the investment-linked insurance apparatus 402 to terminate the investment-linked insurance method. If it is yes in step S110, then the investment-linked insurance method goes back to step S108.

If it is yes in step S109, then step S132 is executed to update the investment-linked policy so that the investment-linked policy further includes a bid record. The bid record comprises a total bid terms, a basis bid, a bid limit, and the aforementioned predetermined amount. If the applicant agrees with the content of the investment-linked policy, he or she will submit a payment of the premium. Next, steps S112 and S113 are respectively executed to enable the investment-linked insurance apparatus 402 to receive the payment and issue the investment-linked policy.

Next, step S114 is executed to enable the investment-linked insurance apparatus 402 to calculate a predetermined bid of a current bid term. Step S115 is executed to enable the investment-linked insurance apparatus 402 to determine whether a placed bid of the current bid term of the applicant is received. If it is not, then step S140 is executed to enable the investment-linked insurance apparatus 402 to calculate a current bid amount by subtracting the basis bid from the bid limit, wherein the current bid amount is to be paid by the applicant. If it is yes in step S115, the step S116 is executed to enable the investment-linked insurance apparatus 402 to determine whether the placed bid is greater than the predetermined bid. If it is not in step S116, then the investment-linked insurance method goes to step S117 to enable the investment-linked insurance apparatus 402 to calculate a current bid amount by subtracting the placed bid from the bid limit, wherein the current bid amount is to be paid by the applicant. It means that the current bid amount is a contribution amount.

If it is yes in step S116, step S118 is executed to enable the investment-linked insurance apparatus 402 to calculate the current bid amount by the equation A=(U−I)×(N−n)+U×(n−1) or

$$A = U \times ( N - n ) + U \times ( n - 1 ) + {\sum }_{i = j}^{n - j} {I}_{i} ,$$

wherein A denotes the current bid amount, U denotes the bid limit, N denotes the total bid terms, n denotes the current bid term, and Iᵢ denotes the placed bids of each bid winner of all the passed terms. The current bid amount is to be received by the applicant. It means that the current bid amount is a bid-winning amount.

After the step S117 and S140, step S119 is executed to enable the investment-linked insurance apparatus 402 to determine whether a request for issuing insurance claim payment is received from the applicant. If it is not, then step S120 is executed to enable the investment-linked insurance apparatus 402 to determine whether the policy ends. If it is not in step S120, then the investment-linked insurance method goes back to step S114. If a request for issuing insurance claim payment is received from the applicant in step S119, then step S122 is executed to enable the investment-linked insurance apparatus 402 to calculate a repayment by multiplying the bid limit and the total future terms. Step S133 is executed to enable the investment-linked insurance apparatus 402 to transmit the request for issuing insurance claim payment to an insurance claim adjustment system. The insurance claim adjustment system calculates the claim amount. It is noted when the insurance claim adjustment system decides to pay the amount of insurance in full amount, the claim amount will be equal to amount of insurance. Next, step S134 is executed to enable the investment-linked insurance apparatus 402 to receive the claim amount from the insurance claim adjustment system. Then, step S123 is executed to pay the repayment and the claim amount to the applicant so that the applicant can receive it.

If the result of the step S120 is that the policy ends, then step S121 is executed to enable the investment-linked insurance apparatus 402 to calculate a repayment by multiplying the bid limit and a value of the total bid terms minus one. Next, step S136 is executed to pay the repayment to the applicant so that the repayment can be received by the applicant.

After the step S118, step S124 is executed to enable the investment-linked insurance apparatus 402 to provide a plurality of investment vehicle for the applicant. The applicant may decide whether to invest these investment vehicles. Step S125 is then executed to enable the investment-linked insurance apparatus 402 to receive a selected investment vehicle, wherein the selected investment vehicle is one of the investment vehicles. Next, step S126 is executed to enable the investment-linked insurance apparatus 402 to store the selected investment vehicle and a net asset value into the database 411.

The investment-linked insurance method then executes step S127 to determine whether the investment-linked insurance apparatus receives a request for issuing insurance claim payment of the applicant. If the result of the step S127 is yes, step S138 is executed to transmit the request for issuing insurance claim payment to an insurance claim adjustment system 404. The insurance claim adjustment system 404 calculates a claim amount. It is noted when the insurance claim adjustment system decides to pay the amount of insurance in full amount, the claim amount will be equal to amount of insurance. Next, step S139 is executed to receive the claim amount from the insurance claim adjustment system. Then, step S131 is executed to enable the investment-linked insurance apparatus 402 to pay the net asset value and the claim amount to the applicant. If it is not in step S127, the investment-linked insurance method further executes step S128 to determine whether the policy period ends. If the policy period has not ended, step S129 is executed to enable the investment-linked insurance apparatus 402 to receive a payment of the bid limit in the next bid term. If step S128 determines that the policy period ends, then step S130 is executed to pay the net asset value to the applicant.

In addition to the aforementioned steps, the second embodiment can also execute all the operations and functions of the investment-linked insurance apparatus described in the first embodiment. How the second embodiment executes these operations and functions will be readily appreciated by those of ordinary skill in the art based on the explanation of the first embodiment, and thus will not be further described herein.

The investment-linked insurance method of the second embodiment may be realized by a computer program. The computer program may be stored on a computer readable medium. The computer readable medium may be a read only memory (ROM), a flash memory, a floppy disk, a hard disk, a compact disk, a mobile disk, a magnetic tape, a database accessible to networks, or any other storage media with the same function and well known to those skilled in the art.

According to the aforementioned descriptions, the investment-linked insurance apparatus and method or the present invention provides a user-friendly environment for an applicant who intends to buy insurances. Furthermore, the investment-linked policy provided by the investment-linked insurance apparatus and method combines the idea of insurance and investment, which offers the applicant more flexibility in handling the money.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An investment-linked insurance apparatus, comprising:
an insurance process module being configured to receive an insurance request of an applicant, create an investment-linked policy of the applicant, and issue the investment-linked policy in response to a payment of a premium of the applicant, the insurance request including an insurance subject-matter, the investment-linked policy including the insurance subject-matter, an amount of insurance, the premium, a policy period, and a bid record, the bid record comprising a total bid terms, a bid limit, and a predetermined amount;
a cash flow module being configured to receive the payment of the premium of the applicant;
a credit evaluation module being configured to determine a credit line of the applicant being greater than the predetermined amount;
a bid process module being configured to receive a placed bid of a current bid term of the applicant and calculate a predetermined bid of the current bid term; and
a database being configured to store the investment-linked policy;
wherein the bid process module is further configured to calculate a current bid amount of the current bid term for the applicant according to the bid limit and one of the placed bid and the predetermined bid.

2. The investment-linked insurance apparatus of claim 1, wherein the credit evaluation module is further configured to decide the credit line of the applicant according to one of a credit information, a collateral, the investment-linked policy, and the combination thereof.

3. The investment-linked insurance apparatus of claim 1, wherein the placed bid is smaller than the predetermined bid, the bid process module is configured to calculate the current bid amount by subtracting the placed bid from the bid limit, and the current bid amount is to be paid by the applicant.

4. The investment-linked insurance apparatus of claim 3, wherein the bid process module is further configured to receive a placed bid of each of the other bid terms and calculate a predetermined bid of each of the other bid terms, each of the placed bids is smaller than the corresponding predetermined bid, the insurance process module is further configured to determine the policy period ending and calculate a repayment by multiplying the bid limit and a value of the total bid terms minus one, and the repayment is to be received by the applicant in response to the ending of the policy period.

5. The investment-linked insurance apparatus of claim 3, wherein the investment-linked insurance apparatus is connected to an insurance claim adjustment system and further comprises:
a compensation module being configured to receive a request for issuing insurance claim payment of the applicant, transmit the request for issuing insurance claim payment to the insurance claim adjustment system, and receive a claim amount from the insurance claim adjustment system;
wherein the insurance process module is further configured to calculate a repayment in response to the receiving of the request for issuing insurance claim payment, the repayment and the claim amount is to be received by the applicant.

6. The investment-linked insurance apparatus of claim 1, wherein the placed bid is greater than the predetermined bid, and the bid process module is configured to calculate the current bid amount by the following equation:
A=(U−I)×(N−n)+U×(n−1);
wherein A denotes the current bid amount, U denotes the bid limit, N denotes the total bid terms, n denotes the current bid term, and I denotes the placed bid.

7. The investment-linked insurance method of claim 1, wherein the placed bid is greater than the predetermined bid, and the calculating step calculates the current bid amount by the following equation:
$$A = U \times ( N - n ) + U \times ( n - 1 ) + {\sum }_{i = j}^{n - j} {I}_{i} ;$$
wherein A denotes the current bid amount, U denotes the bid limit, N denotes the total bid terms, n denotes the current bid term, Iᵢ denotes the placed bids of each bid winner of all the passed terms.

8. The investment-linked insurance apparatus of claim 6, wherein the cash flow module is further configured to receive a payment of the bid limit for each of the rest bid terms.

9. The investment-linked insurance apparatus of claim 6, further comprising:
an investment process module being configured to provide a plurality of investment vehicles for the applicant, receive a selected investment vehicle, and store the selected investment vehicle and a net asset value into the database;
wherein the selected investment vehicle is one of the investment vehicles.

10. The investment-linked insurance apparatus of claim 9, wherein the investment-linked insurance apparatus is connected to an insurance claim adjustment system and further comprises:
a compensation module being configured to receive a request for issuing insurance claim payment of the applicant, transmit the request for issuing insurance claim payment to the insurance claim adjustment system, and receive a claim amount from the insurance claim adjustment system;
wherein the insurance claim adjustment system is further configured to calculate a repayment in response to confirmation of the request for issuing insurance claim payment, the claim amount is related to the amount of insurance, and a summation of the claim amount and the repayment is to be received by the applicant.

11. The investment-linked insurance apparatus of claim 9, wherein the insurance process module is further configured to determine the policy period ending and decide a repayment to be equal to the net asset value, and the repayment is to be received by the applicant in response to the ending of the policy period.

12. The investment-linked insurance apparatus of claim 1, wherein the insurance process module is further configured to receive an electronic certificate of the applicant, receive a piece of basic information of the applicant according to the electronic certificate, examine the piece of basic information, and store the piece of basic information in the database.

13. The investment-linked insurance apparatus of claim 1, wherein the insurance request pertains to one of a property insurance, a health insurance, a casualty insurance, and the combination thereof.

14. An investment-linked insurance method, being adapted to an investment-linked insurance apparatus, the investment-linked insurance method comprising the steps of:
enabling the investment-linked insurance apparatus to receive an insurance request of an applicant, the insurance request including an insurance subject-matter;
enabling the investment-linked insurance apparatus to create an investment-linked policy of the applicant, the investment-linked policy including the insurance subject-matter, an amount of insurance, a premium, a policy period, and a bid record, the bid record comprising a total bid terms, a basis bid, a bid limit, and the predetermined amount;
enabling the investment-linked insurance apparatus to store the investment-linked policy in a database;
enabling the investment-linked insurance apparatus to determine a credit line of the applicant being greater than the predetermined amount;
enabling the investment-linked insurance apparatus to receive a payment of the premium of the applicant;
enabling the investment-linked insurance apparatus to issue the investment-linked policy in response to the receiving of the insurance payment;
enabling the investment-linked insurance apparatus to calculate a predetermined bid of a current bid term;
enabling the investment-linked insurance apparatus to receive a placed bid of the current bid term of the applicant; and
enabling the investment-linked insurance apparatus to calculate a current bid amount of the current bid term for the applicant according to the bid limit and one of the placed bid and the predetermined bid.

15. The investment-linked insurance method of claim 14, further comprising the step of:
enabling the investment-linked insurance apparatus to decide the credit line of the applicant according to one of a credit information, a collateral, the investment-linked policy, and the combination thereof.

16. The investment-linked insurance method of claim 14, wherein the placed bid is smaller than the predetermined bid, the current bid amount is calculated by subtracting the placed bid from the bid limit, and the current bid amount is to be paid by the applicant.

17. The investment-linked insurance method of claim 16, further comprising the steps of:
enabling the investment-linked insurance apparatus to receive a placed bid of each of the other bid terms;
enabling the investment-linked insurance apparatus to calculate a predetermined bid of each of the other bid terms;
enabling the investment-linked insurance apparatus to determine the policy period ending; and
enabling the investment-linked insurance apparatus to calculate a repayment by multiplying the bid limit and a value of the total bid terms minus one;
wherein each of the placed bids is smaller than the corresponding predetermined bid, the repayment is to be received by the applicant in response to the ending of the policy period.

18. The investment-linked insurance method of claim 16, wherein the investment-linked insurance apparatus is connected to an insurance claim adjustment system and the investment-linked insurance method further comprises the steps of:
enabling the investment-linked insurance apparatus to receive a request for issuing insurance claim payment of the applicant;
enabling the investment-linked insurance apparatus to transmit the request for issuing insurance claim payment to the insurance claim adjustment system;
enabling the investment-linked insurance apparatus to receive a claim amount from the insurance claim adjustment system; and
enabling the investment-linked insurance apparatus to calculate a repayment in response to the receiving of the request for issuing insurance claim payment.

19. The investment-linked insurance method of claim 14, wherein the placed bid is greater than the predetermined bid, and the calculating step calculates the current bid amount by the following equation:
A=(U−I)×(N−n)+U×(n−1);
wherein A denotes the current bid amount, U denotes the bid limit, N denotes the total bid terms, n denotes the current bid term, and I denotes the placed bid.

20. The investment-linked insurance method of claim 14, wherein the placed bid is greater than the predetermined bid, and the calculating step calculates the current bid amount by the following equation:
$$A = U \times ( N - n ) + U \times ( n - 1 ) + {\sum }_{i = j}^{n - j} {I}_{i} ;$$
wherein A denotes the current bid amount, U denotes the bid limit, N denotes the total bid terms, n denotes the current bid term, Iᵢ denotes the placed bids of each bid winner of all the passed terms.

21. The investment-linked insurance method of claim 19, further comprising the step of:
enabling the investment-linked insurance apparatus to receive a payment of the bid limit each of the rest bid terms.

22. The investment-linked insurance method of claim 19, further comprising the step of:
enabling the investment-linked insurance apparatus to provide a plurality of investment vehicle for the applicant;
enabling the investment-linked insurance apparatus to receive a selected investment vehicle; and
enabling the investment-linked insurance apparatus to store the selected investment vehicle and a net asset value into the database.

23. The investment-linked insurance method of claim 22, wherein the investment-linked insurance apparatus is connected to an insurance claim adjustment system and the investment-linked insurance method further comprises the steps of:
enabling the investment-linked insurance apparatus to receive a request for issuing insurance claim payment of the applicant;
enabling the investment-linked insurance apparatus to transmit the request for issuing insurance claim payment to the insurance claim adjustment system;
enabling the investment-lined insurance apparatus to receive a claim amount from the insurance claim adjustment system; and
enabling the investment-linked insurance apparatus to calculate a repayment in response to confirmation of the request for issuing insurance claim payment;
wherein the claim amount is related to the amount of insurance, and a summation of the claim amount and the repayment is to be received by the applicant.

24. The investment-linked insurance method of claim 22, further comprising the step of:
enabling the investment-linked insurance apparatus to determine the policy period ends; and
enabling the investment-linked insurance apparatus to decide a repayment to be equal to the net asset value;
wherein the repayment is to be received by the applicant in response to the end of the policy period.

25. The investment-linked insurance method of claim 14, further comprising the steps of:
enabling the investment-linked insurance apparatus to receive an electronic certificate of the applicant;
enabling the investment-linked insurance apparatus to receive a piece of basic information of the applicant according to the electronic certificate;
enabling the investment-linked insurance apparatus to examine the piece of basic information; and
enabling the investment-linked insurance apparatus to store the piece of basic information in the database.

26. The investment-linked insurance method of claim 14, wherein the insurance request pertains to one of a property insurance, a health insurance, a casualty insurance, and the combination thereof.
